(19) United States
(12) Patent Application Publication
(10) Pub. No.: US 2023/0061947 A1
(43) Pub. Date: Mar. 2, 2023

(54) SYSTEMS, METHODS, AND APPARATUSES FOR IMPLEMENTING A BEHAVIORAL RESPONSIVE ADAPTIVE CONTEXT ENGINE (BRACE) FOR EMOTIONALLY-RESPONSIVE EXPERIENCES

(71) Applicant: salesforce.com, inc., San Francisco, CA (US)

(72) Inventors: Frank Caron, San Francisco, CA (US); Peter O'Connell, San Francisco, CA (US); Daniel Thomas Harrison, San Francisco, CA (US); Arastun Efendiyev, San Francisco (IS)

(21) Appl. No.: 17/460,132

(22) Filed: Aug. 27, 2021

(51) Int. Cl. G06Q 30/00; G06N 20/00; G06N 5/02

(52) U.S. Cl. CPC G06Q 30/016; G06N 5/02; G06N 20/00

(57) ABSTRACT

Systems, methods, and apparatuses for implementing a behavioral responsive adaptive context engine for emotionally-responsive experiences are disclosed. According to an exemplary embodiment, there is a system having at least a processor and a memory therein, wherein the system includes a non-transitory machine-readable storage medium that provides instructions that, when executed by the set of one or more processors, the instructions are configurable to cause the system to perform operations including: receiving a pipeline of omni-channel party data having two or more channels of data from different sources; training an artificial intelligence (AI) model using the received pipeline of omni-channel party data; associating the omni-channel party data with a selected user interaction at a graphical user interface (GUI) displayed to a user device; executing the AI model to predict a current emotional state to describe the selected user interaction at the GUI; executing the AI model to output modifications to the GUI configured to bring about a target outcome at the user interface, based on the current emotional state as predicted by the AI model; generating a modified GUI based on the output modifications from the AI model; and transmitting the modified GUI to display at the user device. Other related embodiments are disclosed.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments disclosed herein relate generally to the field of computing and online commerce, and more particularly, to systems, methods, and apparatuses for implementing a Behavioral Responsive Adaptive Context Engine (“BRACE” or “B.R.A.C.E.”) for emotionally-responsive experiences. Such means may be implemented within the computing architecture of a hosted computing environment, such as an on-demand or cloud-computing environment that utilizes multi-tenant database technologies, client-server technologies, traditional database technologies, or other computing architecture in support of the hosted computing environment.

### BACKGROUND

The subject matter discussed in this background section should not necessarily be construed as prior art merely because of its mention in this section. Similarly, a problem mentioned in this section or associated with the subject matter of this section should not be construed as being previously recognized in the prior art. The subject matter in this section merely represents different approaches, which in and of themselves may also correspond to claimed embodiments.

Digital experiences make up a huge portion of how end-consumers interact with brands today. Those experiences include customers completing commerce transactions, learning about a company’s product on a marketing landing page or microsite, and seeking help through a self-serve or directed service portal.

Each of these touchpoints, while facilitated with technology, is still subject to the effects of human emotion. People feel the joy of the impulse click in a moment of commerce as they do the anguish of a dead-end in a service interaction.

These emotions affect the success of the service providers and the likelihood of those customers to continue to interact with them, including meeting organizational objectives such as sales goals and customer satisfaction. By extension, those emotions affect the success of all stakeholders related to the service providers, as well (e.g., software vendors, office building managers, etc.). Any ability to influence these emotions towards the positive can have significant benefits.

The entire presentation or user experience, be it a web interface or the steps of an automated phone system, can be dynamically altered to achieve desired organizational objectives based on the right kind of normalized customer data analysis and decisioning engine.

Problematically, in spite of its potential radical efficacy and broad application, the application of technology to alter user and customer mood via dynamically altering the digital experience in order to achieve desired organizational objectives has not yet been systematized and sufficiently unified, applied, and scaled.

A solution to the problem is therefore necessitated by dynamic customer demand and in fulfillment of organizational objectives by providing a personalized digital experience responsive to the emotions of the user.

The state of the art may therefore benefit from the systems, methods, and apparatuses for implementing a behavioral responsive adaptive context engine (BRACE) for emotionally-responsive experiences, as described herein.

### BRIEF DESCRIPTION OF THE DRAWINGS

Embodiments are illustrated by way of example, and not by way of limitation, and will be more fully understood with reference to the following detailed description when considered in connection with the figures in which:

FIG. 1 depicts an exemplary architecture of a cloud computing environment in accordance with described embodiments;

FIG. 2 depicts an exemplary architecture of the Behavioral Responsive Adaptive Context Engine (BRACE) system in accordance with described embodiments;

FIG. 3 depicts exemplary pseudocode implementation detail for user interface design and association of colors to emotion aliases, in accordance with described embodiments;

FIG. 4 depicts an exemplary flow diagram illustrating conditional logic for BRACE system execution based on context in a service application, in accordance with described embodiments;

FIG. 5 depicts an exemplary implementation of the BRACE system involving angry user interface input, in accordance with described embodiments;

FIG. 6 depicts an exemplary implementation of the BRACE system involving hesitant user interface input, in accordance with described embodiments;

FIGS. 7A-7D depict a flow diagram illustrating a method for implementing a behavioral responsive adaptive context engine (BRACE) for emotionally-responsive experiences; in accordance with described embodiments;

FIG. 8 shows a diagrammatic representation of a system within which embodiments may operate, be installed, integrated, or configured;

FIG. 9A illustrates a block diagram of an environment 998 in which an on-demand database service may operate in accordance with the described embodiments;

FIG. 9B illustrates another block diagram of an embodiment of elements of FIG. 9A and various possible interconnections between such elements in accordance with the described embodiments; and

FIG. 10 illustrates a diagrammatic representation of a machine in the exemplary form of a computer system, in accordance with one embodiment.

### DETAILED DESCRIPTION

Described herein are systems, methods, and apparatuses for implementing a behavioral responsive adaptive context engine (BRACE) for emotionally-responsive experiences. According to an exemplary embodiment, there is a system having at least a processor and a memory therein, wherein the system includes a non-transitory machine-readable storage medium that provides instructions that, when executed by the set of one or more processors, the instructions are configurable to cause the system to perform operations including: receiving a pipeline of omni-channel party data having two or more channels of data from different sources; training an artificial intelligence (AI) model using the received pipeline of omni-channel party data; associating the omni-channel party data with a selected user interaction at a graphical user interface (GUI) displayed to a user device; executing the AI model to predict a current emotional state to describe the selected user interaction at the GUI; executing the AI model to output modifications to the GUI configured to bring about a target outcome at the user interface, based on the current emotional state as predicted by the AI model; generating a modified GUI based on the output modifications from the AI model; and transmitting the modified GUI to display at the user device.

Mechanisms may be utilized to dynamically change the visual style, colorization, sequence, and layout of pages based on the inferred emotion of users interacting with a web or mobile digital property to drive desired behaviors and to promote subconscious correlation of positive (and, by extension, negative) feelings with the interactions on a digital property. These feelings instilled in a user from interactions on a digital property also translate to user feelings towards the brand represented on the digital property.

Previous explorations have found that colors and styles can stimulate certain emotions in people and can also enhance the effectiveness of any given interaction. As many digital experiences consist of layers that can be dynamically colored and styled, there exists an opportunity to understand, and respond to, user emotions in real-time.

Applying both color psychology and propensity analysis to change the user experience in real-time to drive desired actions can allow for dynamic improvement of the user experience and drive better outcomes for both the end-user (e.g., positive experiences) and the end-business interacting with the customer (e.g., higher CSAT, more purchases, less attrition, etc.).

Furthermore, color psychology is really only one area of the study of human emotion that can be affected dynamically. Other case uses may include partner sales enablement, such as dynamically applying color and style when educating third party sales representatives about a product or brand, in order to build trust between the third party sales representative and the company, further increasing the likelihood for the third party sales representative to sell the product or brand over competitor products or brands.

Applicants have defined a set of proprietary, interconnected systems data systems and pipelines that can dynamically aggregate, analyze, understand, and respond with a dynamic experience for any given user-and-system interaction based on emotional state.

This concept can be built, foundationally, by using and extending three different existing technologies and developing new systems to orchestrate data ingestion, contextualization, and presentation in real-time: (i) sentiment and predictive analysis machine learning (machine learning, predictive modeling), (ii) client-side behavior and data capture (e.g., DOM listening, JavaScript, Swift events, etc.), and (iii) client-side visual layer presentation technologies (e.g., JavaScript, CSS, and HTML, etc.).

In order to achieve desired outcomes such as organizational objectives and sales goals, behavior and data capture is fed into and relayed from the cohesive Behavioral Responsive Adaptive Context Engine (BRACE), which is a predictive analysis engine that dynamically injects web and mobile visual and other multimedia styling based on the behavior and data capture.

Previous solutions only partially addressed certain components involved in the present system. For example, there exist tools for data ingestion (such as Heroku Kafka and Mulesoft) and certain systems that contribute to real-time client-side presentation dynamics (such as Interaction Studio). Artificial intelligence tools exist only to determine some aspects of behavioral intent (e.g., Einstein Sentiment Analysis). To date, there has been no single solution for a comprehensive end-to-end mechanism of ingesting, analyzing, and personalizing omni-channel data to determine a user emotional state and recommend a change to user interactions based on the user emotional state. Even further, no solution exists to execute behavioral adaptation by implementing changes to user interactions based on user emotional state.

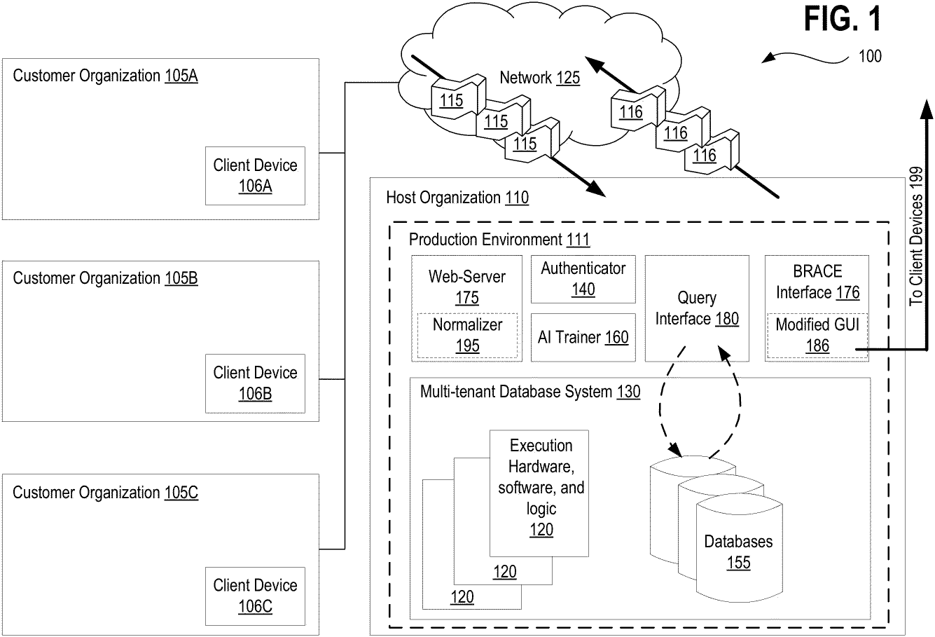

FIG. 1 depicts an exemplary architecture 100 of a cloud computing environment in accordance with described embodiments. In one embodiment, a hosted computing environment 111 is communicably interfaced with a plurality of user client devices 106A-C (e.g., such as mobile devices, smart phones, tablets, PCs, etc.) through host organization 110. In one embodiment, a database system or a multi-tenant database system 130 includes database 155, for example, to store application code, object data, tables, datasets, and underlying database records with user data on behalf of client, or customer, organizations 105A-C.

Certain embodiments may utilize a client-server computing architecture to supplement features, functionality, or computing resources for the multi-tenant database system 130 or alternatively, a computing grid, or a pool of work servers, or some combination of hosted computing architectures may be utilized to carry out the computational workload and processing demanded of the host organization 110 in conjunction with the multi-tenant database system 130.

The exemplary multi-tenant database system 130 depicted here includes a plurality of underlying hardware, software, and logic elements 120 that implement database functionality and a code execution environment within the host organization 110.

In accordance with one embodiment, multi-tenant database system 130 utilizes the underlying database system 155 to service database queries and other data interactions with the multi-tenant database system 130 that communicate with the multi-tenant database system 130 via the query interface. The hardware, software, and logic elements 120 of the multi-tenant database system 130 are separate and distinct from a plurality of customer organizations (105A, 105B, and 105C) which utilize web services and other service offerings as provided by the host organization 110 by communicably interfacing to the host organization 110 via network 125. In such a way, host organization 110 may implement on-demand services, on-demand database services, or cloud computing services to subscribing customer organizations 105A-C.

Further depicted is the host organization 110 receiving input and other requests 115 from a plurality of customer organizations 105A-C via network 125 (such as a public Internet). For example, incoming search queries, database queries, API requests, interactions with displayed graphical user interfaces and displays at the user client devices 106A-C, or other inputs may be received from the customer organizations 105A-C to be processed against the multi-tenant database system 130, or such queries may be constructed from the inputs and other requests 115 for execution against the databases 155 or the query interface 180, pursuant to which results 116 are then returned to an originator or requestor, such as a user of one of the user client devices 106A-C at a respective customer organization 105A-C.

In one embodiment, each customer organization 105A-C is an entity selected from the group consisting of: a separate and distinct remote organization, an organizational group within the host organization 110, a business partner of the host organization 110, or a customer organization 105A-C that subscribes to cloud computing services provided by the host organization 110.

In one embodiment, requests 115 are received at, or submitted to, a web-server 175 within host organization 110. Host organization 110 may receive a variety of requests for processing by the host organization 110 and its multi-tenant database system 130. Incoming requests 115 received at web-server 175 may specify which services from the host organization 110 are to be provided, such as query requests, search request, status requests, database transactions, graphical user interface requests and interactions, processing requests to retrieve, update, or store data on behalf of one of the customer organizations 105A-C, code execution requests, and so forth. Web-server 175 may be responsible for receiving requests 115 from various customer organizations 105A-C via network 125 on behalf of the query interface 180 and for providing a web-based interface or other graphical displays to an end-user user client device 106A-C or machine originating such data requests 115.

The query interface 180 is capable of receiving and executing requested queries against the database and storage components of the multi-tenant database system 130 so as to return a result set, response, or other requested data in furtherance of the methodologies described. The query interface 180 additionally provides functionality to pass queries from web-server 175 into the multi-tenant database system 130 for execution against the databases 155 for processing search queries, or into the other available data stores of the host organization’s computing environment 111. In one embodiment, the query interface 180 implements an Application Programming Interface (API) through which queries may be executed against the databases 155 or the other data stores.

Host organization 110 may implement a BRACE interface 176 via web-server 175 or as a stand-alone interface to process and execute user interface modification functions based on omni-channel aggregate data or requests 115 received from the user client devices 106A-C. BRACE interface 176 further supports AI trainer 160 to improve a pre-trained AI model 615 in predicting an emotional state associated with user interactions at client devices 106A-106C and, pursuant to this prediction, the generating and sending of a modified GUI 186 in an outgoing direction from host organization 110 to the user client devices 199. Thus, BRACE interface 176 supports changing interfaces at client devices 106A-106C, in accordance with a pre-selected target outcome for interactions at client devices 106A-106C, based on the predicted emotional state associated with user interactions at client devices 106A-106C.

Authenticator 140 operates on behalf of the host organization to verify, authenticate, and otherwise credential users attempting to gain access to the host organization. According to certain embodiments, authenticator 140 may also verify the authenticity of received data 115, such as a pipeline of omni-channel aggregate data from client devices 106A-C.

Still further depicted within the hosted computing environment 111 is normalizer 195. Normalizer 195 operates to normalize and contextualize received data 115, such as a pipeline of omni-channel aggregate data from client devices 106A-106C. Normalizer 195 prepares data for processing by BRACE interface 176 by removing or contextualizing aberrations affecting received data 115 such as fast typing entry, mouse clicks, etc. According to certain embodiments, the contextualization of received data 115 involves normalizer 195 consolidating various portions of received data 115, such as data 201 (i.e. transactional data 202) with sources 205 (i.e. social sources 206) to contextualize user interactions at user interfaces of client devices 106A-106C. According to certain embodiments, AI trainer 160 may receive information or settings from normalizer 195 to improve pre-trained AI model 615.

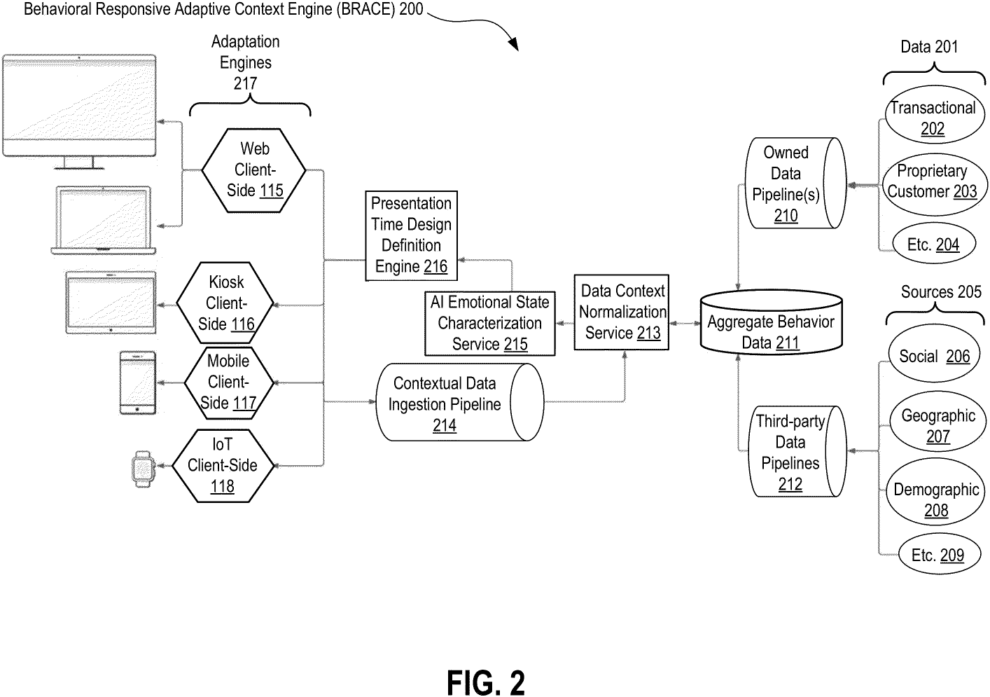

FIG. 2 depicts an exemplary architecture of the Behavioral Responsive Adaptive Context Engine (BRACE) system 200 in accordance with described embodiments.

As shown here, all-digital experience touchpoints 201-209 will feed information about the current user’s behavior into aggregate behavior data 211. Aggregate behavior data 211 may omni-channel party data including first-party data (owned data pipeline(s) 210) as well as third-party data pipelines 212. Owned data pipeline(s) 210 may include user transactional data 202, proprietary customer data 203, and other forms of data etc. such as user behavioral data 203. Other forms of data, etc. such as user behavioral data 203 may include data such as active vs. passive presence of the user at a user interface, the content and speed of text being entered, the duration of a user interaction on a webpage or user interface, and measurements relating to other user interactions such as mouse clicks and movements, navigation, and frequency of visits.

Owned data pipleline(s) 210 may be stored within the platform that the BRACE system 200 is operating on, or may be stored within platforms or applications external to BRACE system 200.

Third-party data pipelines 212 may include both second party data such as social sources 206 (e.g., social media) as well as third party data such as environmental and non-user owned data including geographic sources 207 (e.g., weather), demographic sources 208 (e.g., census) 107, etc. 209.

Aggregate behavior data 211 will be normalized and related to the user via data context normalization service 213, which receives contextual information from contextual data ingestion pipeline 214.

The normalized and contextualized data is then fed to the AI emotional state characterization service 215, which will evaluate that behavior in isolation and in contrast to its persisted store of past behaviors (e.g., an event stream fed into an AI service which is persisted and parsed).

The AI emotional state characterization service 215 will use this information to make a prediction and feed back to the digital experience layer (presentation time design definition engine 216) a directed emotional response as well as a prescribed change to the user interface, which will be injected into the user interface experience using the visual layer technologies available such as various platform-specific adaptation engines 217 for web 115, kiosk 116, mobile 117, and Internet of Things (IoT) 118 client-side adaptation engines.

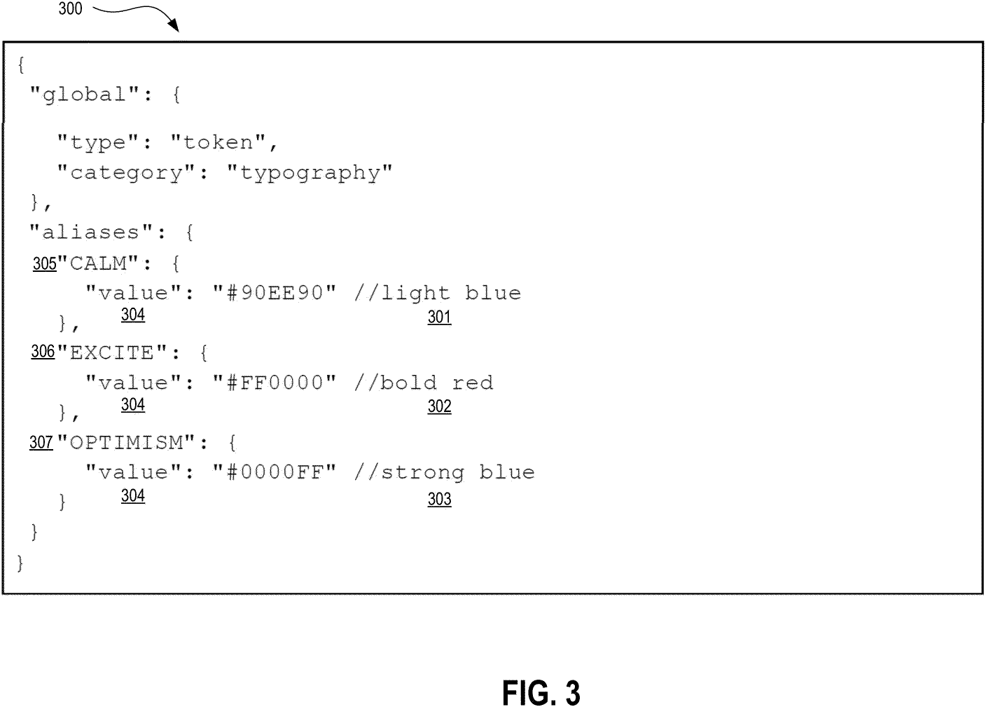

FIG. 3 depicts exemplary pseudocode implementation detail 300 for user interface design and association of colors to emotion aliases, in accordance with described embodiments.

As shown here, there is a sample CSS construct to align color psychology with web technology. Web layer technology for variable visual colors (light blue 301, bold red 302, and strong blue 303) is defined with a “value” 304 to apply color psychology’s principles to the web technology to facilitate the appropriate visual representation of the desired emotional stimulus (“CALM” 305, “EXCITE” 306, and “OPTIMISM” 307).

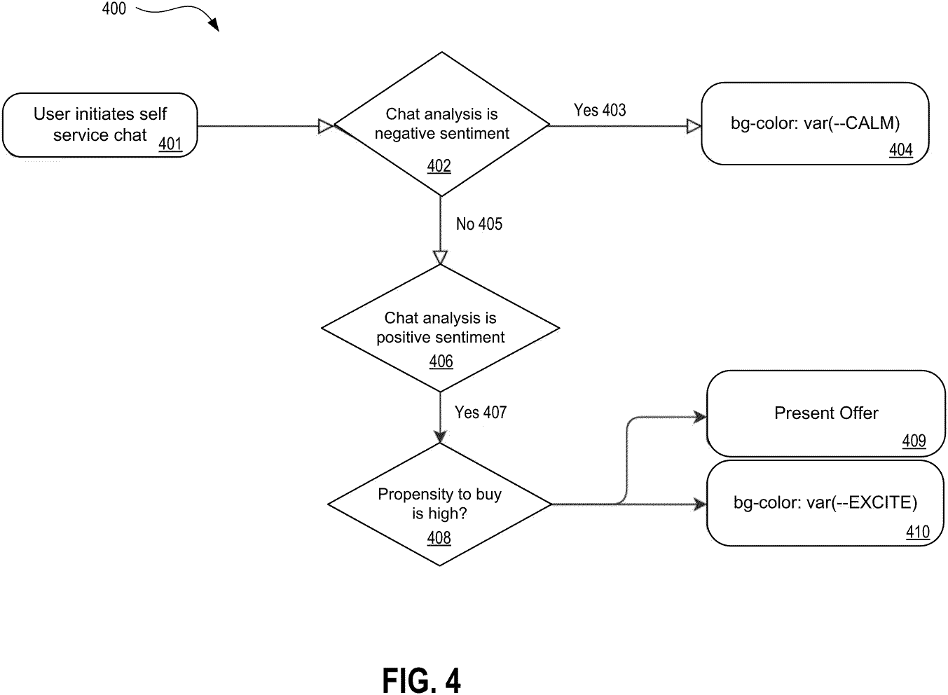

FIG. 4 depicts an exemplary flow diagram 400 illustrating conditional logic for BRACE system execution based on context in a service application, in accordance with described embodiments.

The matching of color to sentiment is not enough to implement the BRACE system. As shown here, it must be intelligently and dynamically applied to the presentation layer where appropriate. FIG. 4 shows a representation of additional web application logic in the form of a simple algorithmic example in the context of a service application. Here, the appropriate color psychology digitalization is applied dynamically on the ongoing BRACE analysis and execution of the appropriate decision logic.

At block 401, the user initiates a self-service chat. At block 402, web application logic determines if there is negative sentiment based on chat analysis. If negative sentiment is found 403, then at block 404, the background color may be set based on a variable menu of colors defined as instilling calm emotion.

If negative sentiment is not found 405, then at block 406, chat analysis determines if there is positive sentiment. If positive sentiment is found 407, then chat analysis determines if user propensity to buy is high at block 408. If user propensity is found to be high, then web application logic may, at block 409, present an offer to the user, or alternatively, at block 410, set background color based on a variable menu of colors defined as instilling the emotion of excitement.

FIG. 4 represents just one simple example of how client-side interfaces can be altered based on various data inputs. The same approach can be applied to arbitrary design and run-time applications based on aggregate data for countless different human emotional contexts, and that experience can be executed in arbitrary touchpoints across all known and future devices.

With BRACE in place, opportunities exist to provide additional controls to administrators to extend and enhance user emotional responses. The efficacy of historical emotional response tweaks can be measured and used to further improve future efficacy, for example by retraining AI models.

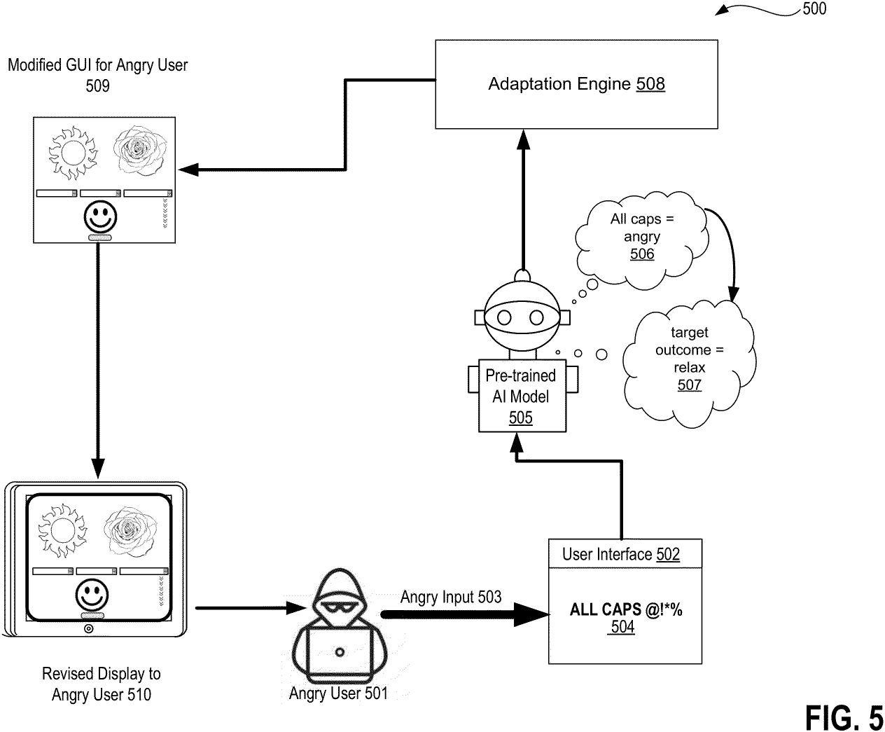

FIG. 5 depicts an exemplary implementation 500 of the BRACE system involving angry user interface input, in accordance with described embodiments.

As shown here, there is an angry user 501 interacting with user interface 502, for example to get product or customer support. According to certain embodiments, angry user 501 may be a human being or a bot. Angry user 501 is frustrated with the speed or quality of the interaction at user interface 502 and enters angry input 503 for display at user interface 502. Angry input 503 may be, for example, all caps and/or expletive text 504.

Pre-trained AI model 505 monitoring user interface 502 recognizes the all caps and/or expletive text 611 and associates them with the user interaction at user interface 502. Pre-trained AI model 505 then predicts an emotional state of anger 506 associated with the user interaction at user interface 502, for example utilizing the logic described in FIG. 4. Following this, pre-trained AI model 505 outputs instruction to adaptation engine 508 to accomplish a target outcome 507 based on the predicted emotional state of anger 506. Target outcome 507 may be, for example, relaxing angry user 501.

Responsive to instructions from pre-trained AI model 505, adaptation engine 508 assists pre-trained AI model 505 in generating a modified GUI for angry user 509, in furtherance of target outcome 507. Modified GUI for angry user 509 may include, for example, changes to the colors, design, screen flow, expedited options for customer or technical assistance by, for example, escalating the user interaction to a higher level of service, menus, alerts, graphics, and other multimedia, etc. of user interface 502 in order to placate angry user 501 with a relaxing ambiance, display, support, or other outputs in furtherance of target outcome 507 of relaxing angry user 501. In the final step, modified GUI for angry user 509 is implemented and presented as a revised display to angry user 510.

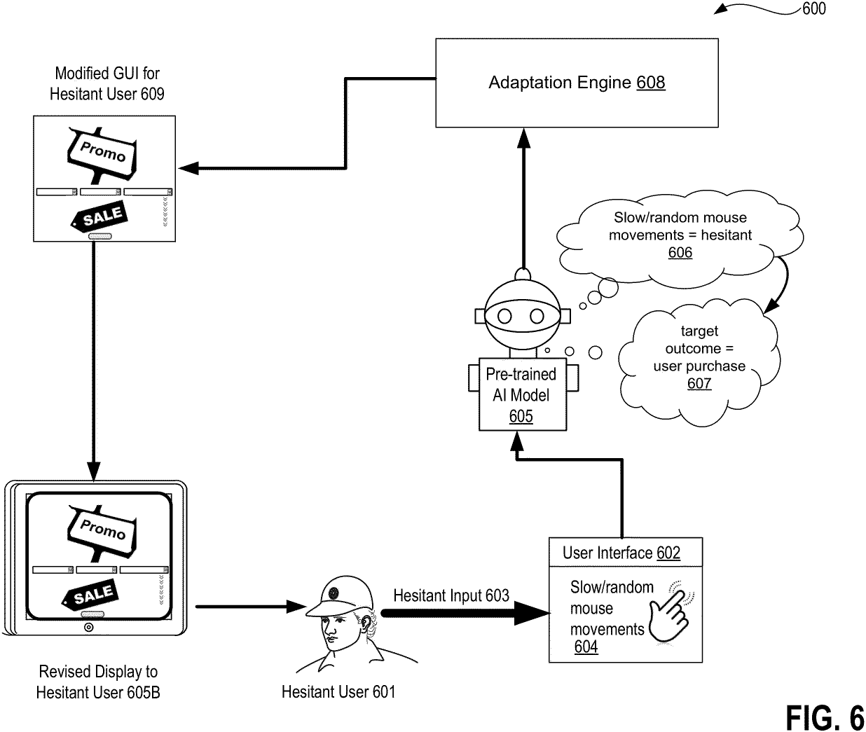

FIG. 6 depicts an exemplary implementation 600 of the BRACE system involving hesitant user interface input, in accordance with described embodiments.

As shown here, there is a hesitant user 601 interacting with user interface 602, for example, to buy a product or service. According to certain embodiments, hesitant user 601 may be a human being or a bot. Hesitant user 601 is uncertain about purchasing the product or service and enters hesitant input 603 for display at user interface 602. Hesitant input 603 may be, for example, slow/random mouse movements 604 or navigating backward on pages or checkout screens.

Pre-trained AI model 605 monitoring user interface 602 recognizes the slow/random mouse movements 604 or navigating backward on pages or checkout screens and associates them with the user interaction at user interface 602. Pre-trained AI model 605 then predicts an emotional state of hesitation 606 associated with the user interaction at user interface 602, for example utilizing the logic described in FIG. 4. Following this, pre-trained AI model 605 outputs instruction to adaptation engine 608 to accomplish a target outcome 607 based on the predicted emotional state of hesitation 606. Target outcome 607 may be, for example, eliciting a user purchase.

Responsive to instructions from pre-trained AI model 605, adaptation engine 608 assists pre-trained AI model 605 in generating a modified GUI for hesitant user 609, in furtherance of target outcome 607. Modified GUI for hesitant user 609 may include, for example, changes to the colors, design, screen flow, menus, alerts, graphics, and other multimedia of user interface 602 in order to advertise sales, promotions, discounts, or other offers in furtherance of the target outcome 607 of eliciting a user purchase at user interface 602. In the final step, modified GUI for hesitant user 609 is implemented and presented as a revised display to hesitant user 601.

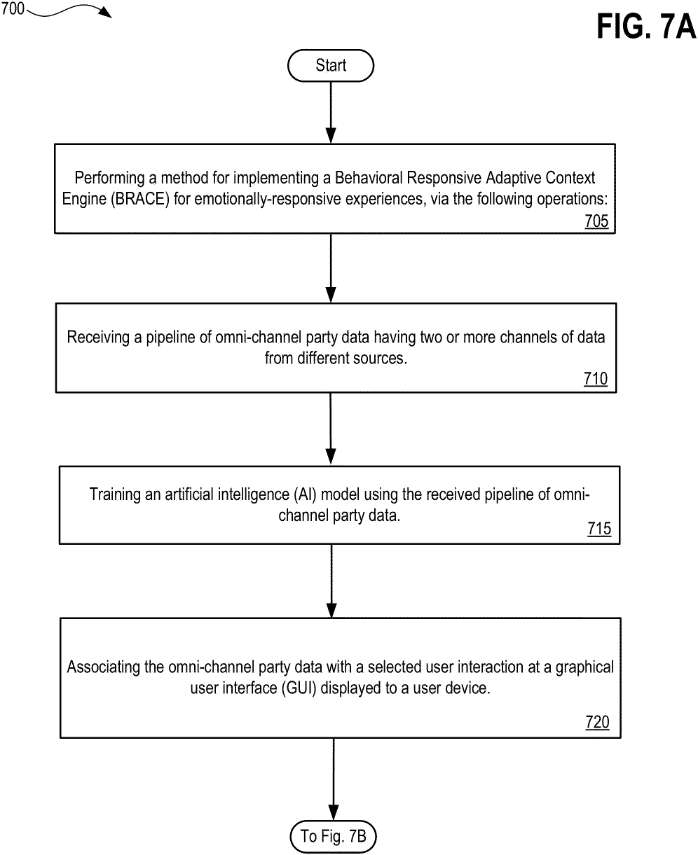

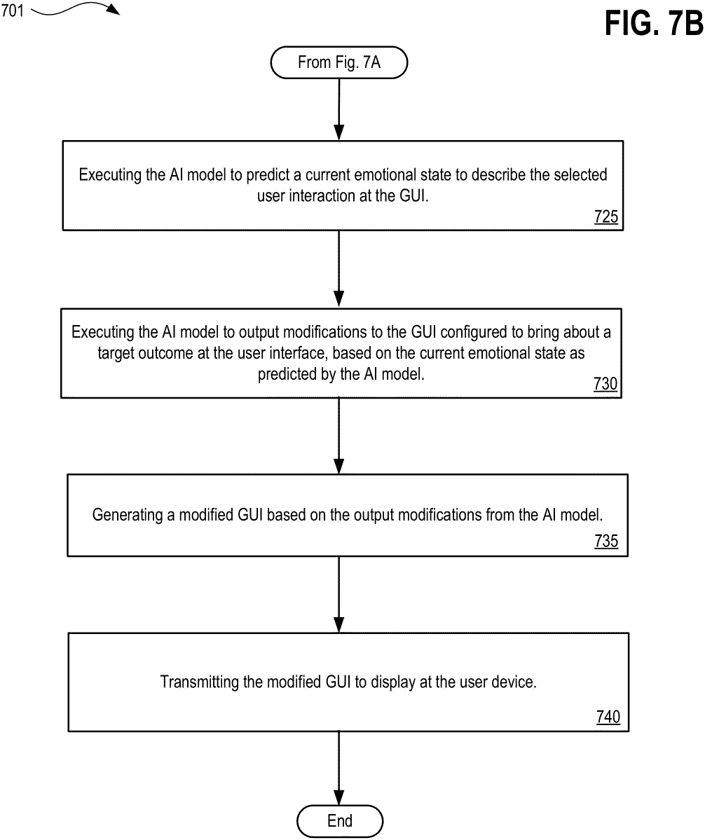

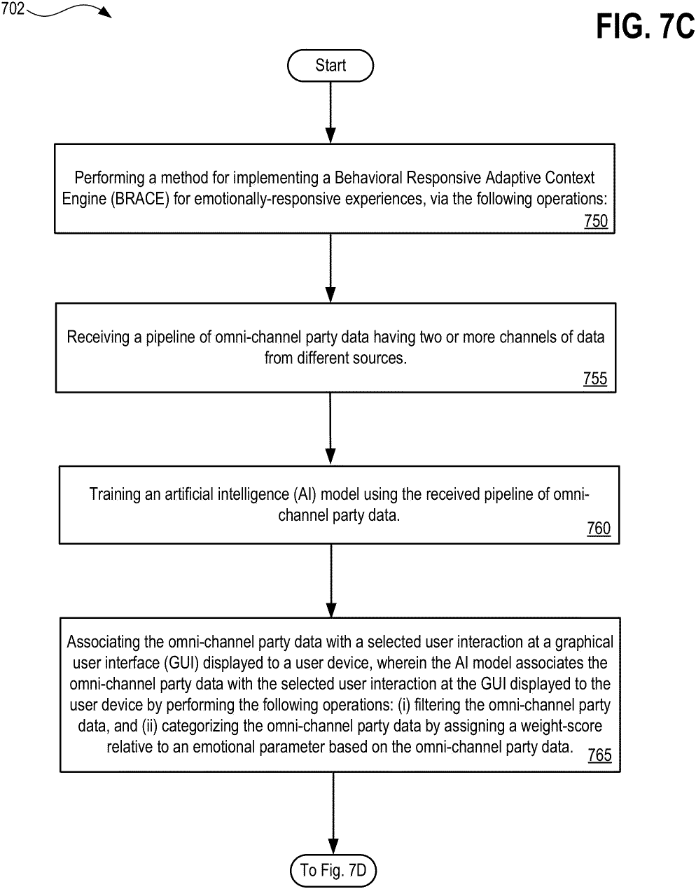

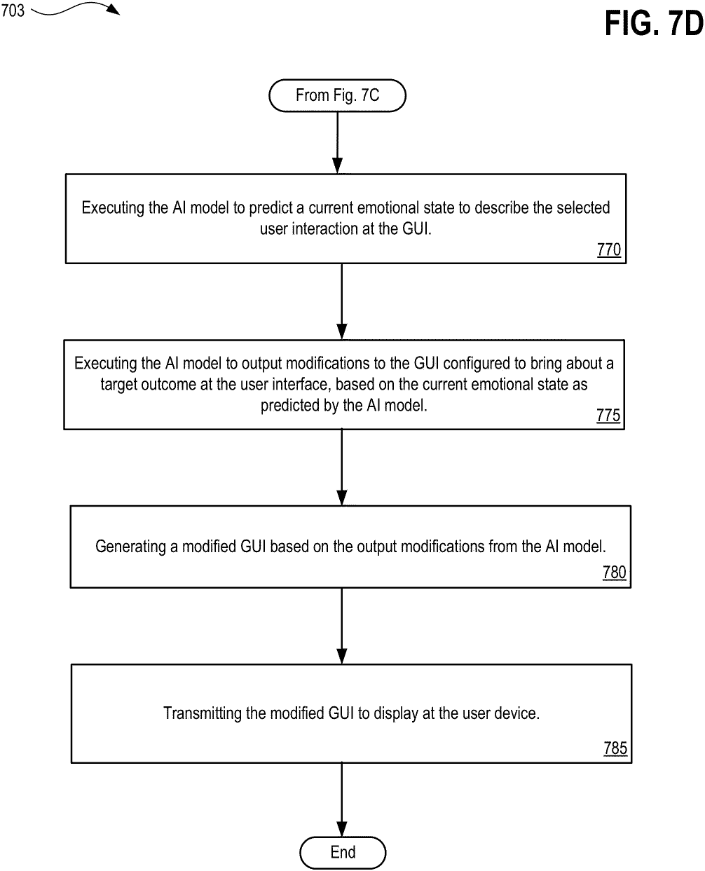

FIGS. 7A-7D depict a flow diagram illustrating a method 700-703 for implementing a behavioral responsive adaptive context engine (BRACE) for emotionally-responsive experiences within a computing environment such as a database system implementation supported by a processor and a memory to execute such functionality to provide cloud-based on-demand functionality to users, customers, and subscribers.

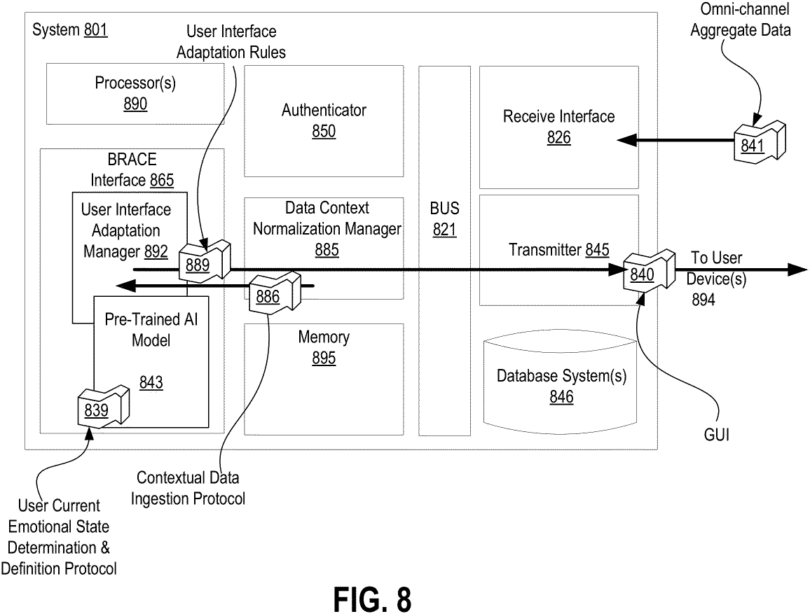

Method 700-703 may be performed by processing logic that may include hardware (e.g., circuitry, dedicated logic, programmable logic, microcode, etc.), software (e.g., instructions run on a processing device) to perform various operations such as executing, transmitting, receiving, analyzing, triggering, pushing, recommending, defining, retrieving, parsing, persisting, exposing, loading, operating, generating, storing, maintaining, creating, returning, presenting, interfacing, communicating, querying, processing, providing, determining, displaying, updating, sending, etc., in pursuance of the systems and methods as described herein. For example, system 801 and database system 846 as depicted at FIG. 8, as well as other complementary systems may operate in collaboration to implement the described methodologies. Some of the blocks and/or operations listed below are optional in accordance with certain embodiments. The numbering of the blocks presented is for the sake of clarity and is not intended to prescribe an order of operations in which the various blocks must occur.

With reference to the method 700-701 depicted at FIG. 7A, at block 705, processing begins by performing a method for implementing a behavioral responsive adaptive context engine (BRACE) for emotionally-responsive experiences, via the following operations:

At block 710, processing logic receives a pipeline of omni-channel data having two or more channels of data from different sources.

At block 715, processing logic trains an artificial intelligence (AI) model using the received pipeline of omni-channel party data.

At block 720, processing logic associates the omni-channel party data with a selected user interaction at a graphical user interface (GUI) displayed to a user device.

Method 700-701 continues at FIG. 7B.

At block 725, processing logic executes the AI model to predict a current emotional state to describe the selected user interaction at the GUI.

At block 730, processing logic executes the AI model to output modifications to the GUI configured to bring about a target outcome at the user interface, based on the current emotional state as predicted by the AI model.

At block 735, processing logic generates a modified GUI based on the output modifications from the AI model.

At block 740, processing logic transmits the modified GUI to display at the user device.

With reference to the method 702-703 depicted at FIG. 7C, at block 750, processing begins by performing a method for implementing a behavioral responsive adaptive context engine (BRACE) for emotionally-responsive experiences, via the following operations:

At block 755, processing logic receives a pipeline of omni-channel data having two or more channels of data from different sources.

At block 760, processing logic trains an artificial intelligence (AI) model using the received pipeline of omni-channel party data.

At block 765, processing logic associates the omni-channel party data with a selected user interaction at a graphical user interface (GUI) displayed to a user device, wherein the AI model associates the omni-channel party data with the selected user interaction at the GUI displayed to the user device by performing the following operations: (i) filtering the omni-channel party data, and (ii) categorizing the omni-channel party data by assigning a weight-score relative to an emotional parameter based on the omni-channel party data.

Method 702-703 continues at FIG. 7D.

At block 770, processing logic executes the AI model to predict a current emotional state to describe the selected user interaction at the GUI.

At block 775, processing logic executes the AI model to output modifications to the GUI configured to bring about a target outcome at the user interface, based on the current emotional state as predicted by the AI model.

At block 780, processing logic generates a modified GUI based on the output modifications from the AI model.

At block 785, processing logic transmits the modified GUI to display at the user device.

According to another embodiment of method 700-701, the omni-channel pipeline of party data further includes one or more of: (i) first party data, wherein first party data includes user owned data internal to the system including: customer relation management (CRM) data, user inputs including sentiment of user-inputted text, user behavioral data including voice and facial expressions, user GUI interaction data, and user transaction history; (ii) second party data, wherein second party data includes external user owned data including: social media data, user external account data, user medical records, and user credit reports; and (iii) third party data, wherein third party data includes non-user owned data and environmental data including: user location and geographic data, weather data, stock market data, demographic data, local news, and national news.

According to another embodiment of method 700-701, one or more of: (i) predicting the current emotional state to describe the selected user interaction at the GUI, and (ii) output modifications to the GUI configured to bring about a target outcome at the user interface based on the current emotional state as predicted by the AI model, are based on pre-configured options.

According to another embodiment of method 700-701, the predictive capabilities of the AI model are improved via reinforcement learning, wherein the AI model bases one or more of the following on data received from completed user transactions: (i) predicting the current emotional state to describe the selected user interaction at the GUI, and (ii) output modifications to the GUI configured to bring about a target outcome at the user interface based on the current emotional state as predicted by the AI model.

According to another embodiment of method 700-701, output modifications to the GUI configured to bring about a target outcome at the user interface based on the current emotional state as predicted by the AI model include changing one or more of user interface: (i) design, including colors, (ii) screen flow including expediting or escalating user interactions, (iii) products presentation, including product type and product description, (iv) method, frequency, and content of advertising to the user including discounts, promotions, and push notifications, and (v) relationship status between the user and the user interface, including termination of the user.

According to another embodiment of method 700-701, filtering the omni-channel party data includes one or more of: (i) standardizing the omni-channel party data, (ii) filtering out bots and malicious data, (iii) contextualizing user input and user input rates including typing speed, mouse clicks, user video, and user audio, and (iv) fine-tuning the omni-channel party data to remove aberrations.

According to another embodiment of method 700-701, the target outcome at the user interface based on the current emotional state as predicted by the AI model is based on a relevant business goal including one or more of: (i) sales goals, (ii) customer satisfaction and retention, (iii) cost function, and (iv) optimization functions.

According to another embodiment of method 700-701, executing the AI model to predict a current emotional state to describe the selected user interaction at the GUI includes selecting from a configurable and combinable list of individual emotional states based on rule sets, in which the AI model adds to the list via machine learning.

According to another embodiment of method 700-701, the selected user interaction at the GUI displayed to the user device is an online shopping interaction, in which the AI model predicts a current emotional state of hesitation to describe the selected user interaction at the GUI based on user mouse movements, in which the output modifications to the GUI configured to bring about a target outcome at the user interface based on the current emotional state as predicted by the AI model include changing the color and style of the user interface, wherein the omni-channel party data includes one or more of: (i) live local weather conditions, and (ii) user transaction history, and in which the target outcome at the user interface based on the current emotional state as predicted by the AI model includes making a sale via instilling a desired emotional state of excitement at the selected user interface.

According to another embodiment of method 700-701, the selected user interaction at the GUI displayed to the user device is text-based customer support, in which the AI model predicts a current emotional state of frustration to describe the selected user interaction at the GUI based on one or more of: (i) frequency of visits to a website in the last 24 hours, (ii) user financial data, and (iii) sentiment of user-inputted text, in which the output modifications to the GUI configured to bring about a target outcome at the user interface based on the current emotional state as predicted by the AI model include one or more of: (i) changing the color and style of the user interface, and (ii) expediting support process screen flow, in which the target outcome at the user interface based on the current emotional state as predicted by the AI model includes satisfactory customer service via instilling a desired emotional state of calm at the selected user interface.

According to another embodiment of method 700-701, the selected user interaction at the GUI displayed to the user device is interaction with a sales prospect, in which the outputted modifications to the GUI configured to bring about a desired outcome at the user interface includes changing the color and style of the user interface, in which the desired outcome at the user interface via the modified GUI is to convert the sales prospect into a sale via instilling a desired emotional state of trust at the selected user interface based on the sales prospect perceiving the user interface as optimistic and friendly, in which the sales prospect becomes receptive to providing leads on information to complete a sale.

In accordance with a particular embodiment of method 700-701, there is a non-transitory computer readable storage medium having instructions stored thereupon that, when executed by a host organization having at least a processor and a memory therein, the instructions cause the processor to perform operations including: receiving a pipeline of omni-channel party data having two or more channels of data from different sources; training an artificial intelligence (AI) model using the received pipeline of omni-channel party data; associating the omni-channel party data with a selected user interaction at a graphical user interface (GUI) displayed to a user device; executing the AI model to predict a current emotional state to describe the selected user interaction at the GUI; executing the AI model to output modifications to the GUI configured to bring about a target outcome at the user interface, based on the current emotional state as predicted by the AI model; generating a modified GUI based on the output modifications from the AI model; and transmitting the modified GUI to display at the user device.

According to yet another embodiment of method 700-701, there is a specially configurable system, customized to include a memory to store instructions; a set of one or more processors; and a non-transitory machine-readable storage medium that provides instructions that, when executed by the set of one or more processors, the instructions stored in the memory are configurable to cause the system to perform the following operations: receiving a pipeline of omni-channel party data having two or more channels of data from different sources; training an artificial intelligence (AI) model using the received pipeline of omni-channel party data; associating the omni-channel party data with a selected user interaction at a graphical user interface (GUI) displayed to a user device; executing the AI model to predict a current emotional state to describe the selected user interaction at the GUI; executing the AI model to output modifications to the GUI configured to bring about a target outcome at the user interface, based on the current emotional state as predicted by the AI model; generating a modified GUI based on the output modifications from the AI model; and transmitting the modified GUI to display at the user device.

FIG. 8 shows a diagrammatic representation of a system 801 within which embodiments may operate, be installed, integrated, or configured. In accordance with one embodiment, there is a system 801 having at least a processor 890 and a memory 895 therein to execute implementing application code for the methodologies as described herein. Such a system 801 may communicatively interface with and cooperatively execute with the benefit of a hosted computing environment, such as a host organization, a multi-tenant environment, an on-demand service provider, a cloud-based service provider, a client-server environment, etc.

According to the depicted embodiment, system 801, which may operate within a host organization, includes the processor 890 and the memory 895 to execute instructions at the system 801. According to such an embodiment, the processor 890 is to execute a Behavioral Responsive Adaptive Context Engine (“BRACE”) for emotionally-responsive experiences. Internal to the BRACE interface 865, there is depicted the user interface adaptation manager 892.

As shown here, the user interface adaptation manager 892 is capable of receiving and applying user interface adaptation rules 889 in the generation of a GUI 840. According to certain embodiments, user interface adaptation rules 889 may be configured or modified by pre-trained AI model 843 based on output received from the data context normalization manager 885 and user current emotional state determination and definition protocol 839.

A receive interface 826 of the system 801 is to receive a pipeline of omni-channel aggregate data 841 which will be sent to authenticator 850 for authentication. According to certain embodiments, the pipeline of omni-channel data 841 has two or more channels of data from different sources. According to other embodiments, the pipeline of omni-channel aggregate data 841 may be used to train pre-trained AI model 843.

At this point, the pipeline of omni-channel aggregate data 841 may be associated with a selected user interaction at a user interface of user device 894, for example, via data context normalization manager 885 relating the pipeline of omni-channel aggregate data 841 back to a selected user interaction at a user interface of user device 894. Data context normalization manager 885 may further apply contextual data ingestion protocol 886 to normalize and standardize the pipeline of omni-channel aggregate data 841 by removing aberrations. As previously discussed, the pipeline of omni-channel aggregate data 841 may include party data from various sources including first party, second party, and third party data.

Bus 821 interfaces the various components of the system 801 amongst each other, with any other peripheral(s) of the system 801, and with external components such as external network elements, other machines, client devices, cloud computing services, etc. Communications may further include communicating with external devices via a network interface over a LAN, WAN, or the public Internet. Authenticator 850 provides authentication services for users seeking access to the database systems 846. According to certain embodiments, authenticator 850 may authenticate the pipeline of omni-channel aggregate data 841, for example in coordination with data context normalization manager 885.

According to a particular embodiment of system 801, the system is to execute at a host organization. As shown here, such a system includes: a memory 895 to store instructions; a processor 890 to execute instructions; in which the processor 890 is to execute a BRACE interface 865; a transmitter 845 to transmit a modified Graphical User Interface (GUI Interface) 840 from the system to a user device 894 communicably interfaced with the system over a network for display, a receive interface 826 of the system to receive receiving input, the input including a pipeline of omni-channel aggregate data 841 to be normalized via data context normalization manager 885 and contextualized via contextual data ingestion protocol 886, in which the pre-trained AI model 843 is to predict a current emotion state to describe a selected user interaction at a user interface of a user device, for example via user emotional state determination and definition protocol 839. In the implementation stage, user interface adaption manager 892 of BRACE interface 865 is to generate a modified GUI 840 based on output modifications from pre-trained AI model 843 and in accordance with user interface adaptation rules 889, which may include a target outcome for the user interaction at the user device 894 based on the current emotional state of a user predicted by pre-trained AI model 843, for example via user emotional state determination and definition protocol 839. The modified GUI 840 is then transmitted to user device 894 via transmitter 845.

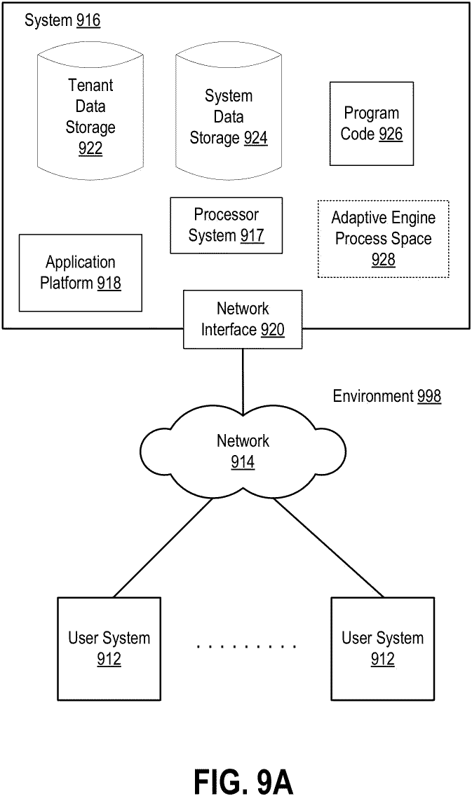

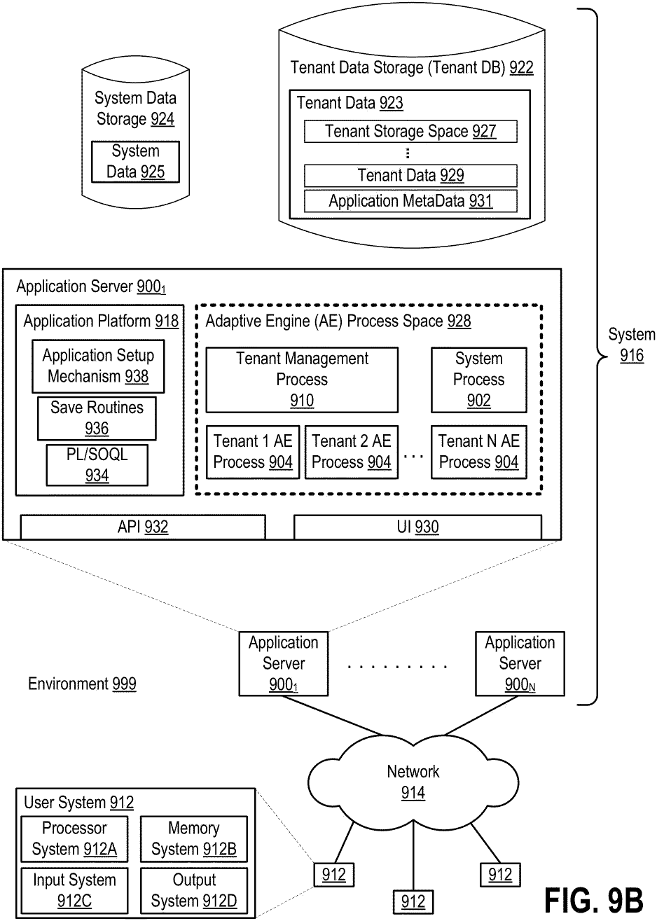

FIG. 9A illustrates a block diagram of an environment 998 in which an on-demand database service may operate in accordance with the described embodiments. Environment 998 may include user systems 912, network 914, system 916, processor system 917, application platform 918, network interface 920, tenant data storage 922, system data storage 924, program code 926, and adaptive engine process space 928. In other embodiments, environment 998 may not have all of the components listed and/or may have other elements instead of, or in addition to, those listed above.

Environment 998 is an environment in which an on-demand database service exists. User system 912 may be any machine or system that is used by a user to access a database user system. For example, any of user systems 912 can be a handheld computing device, a mobile phone, a laptop computer, a workstation, and/or a network of computing devices. As illustrated in FIG. 9A (and in more detail in FIG. 9B) user systems 912 might interact via a network 914 with an on-demand database service, which is system 916.

An on-demand database service, such as system 916, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 916” and “system 916” are used interchangeably herein. A database image may include one or more database objects. A relational database management system (RDMS) or the equivalent may execute storage and retrieval of information against the database object(s). Application platform 918 may be a framework that allows the applications of system 916 to run, such as the hardware and/or software, e.g., the operating system. In an embodiment, on-demand database service 916 may include an application platform 918 that enables creating, managing, and executing one or more applications developed by the provider of the on-demand database service, users accessing the on-demand database service via user systems 912, or third party application developers accessing the on-demand database service via user systems 912.

The users of user systems 912 may differ in their respective capacities, and the capacity of a particular user system 912 might be entirely determined by permissions (permission levels) for the current user. For example, where a salesperson is using a particular user system 912 to interact with system 916, that user system has the capacities allotted to that salesperson. However, while an administrator is using that user system to interact with system 916, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user’s security or permission level.

Network 914 is any network or combination of networks of devices that communicate with one another. For example, network 914 can be anyone or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it is understood that the networks that the claimed embodiments may utilize are not so limited, although TCP/IP is a frequently implemented protocol.

User systems 912 might communicate with system 916 using TCP/IP and, at a higher network level, use other common Internet protocols to communicate, such as HTTP, FTP, AFS, WAP, etc. In an example where HTTP is used, user system 912 might include an HTTP client commonly referred to as a “browser” for sending and receiving HTTP messages to and from an HTTP server at system 916. Such an HTTP server might be implemented as the sole network interface between system 916 and network 914, but other techniques might be used as well or instead. In some implementations, the interface between system 916 and network 914 includes load sharing functionality, such as round-robin HTTP request distributors to balance loads and distribute incoming HTTP requests evenly over a plurality of servers. At least as for the users that are accessing that server, each of the plurality of servers has access to the MTS’ data; however, other alternative configurations may be used instead.

In one embodiment, system 916, shown in FIG. 9A, implements a web-based customer relationship management (CRM) system. For example, in one embodiment, system 916 includes application servers configured to implement and execute CRM software applications as well as provide related data, code, forms, webpages, and other information to and from user systems 912 and to store to and retrieve related data, objects, and Webpage content from a database system. With a multi-tenant system, data for multiple tenants may be stored in the same physical database object, however, tenant data typically is arranged so that data of one tenant is kept logically separate from that of other tenants so that one tenant does not have access to another tenant’s data, unless such data is expressly shared. In certain embodiments, system 916 implements applications other than, or in addition to, a CRM application. For example, system 916 may provide tenant access to multiple hosted (standard and custom) applications, including a CRM application. User (or third party developer) applications, which may or may not include CRM, may be supported by the application platform 918, which manages the creation and storage of the applications into one or more database objects, and executing of the applications in a virtual machine in the process space of the system 916.

One arrangement for elements of system 916 is shown in FIG. 9A, including a network interface 920, application platform 918, tenant data storage 922 for tenant data 923, system data storage 924 for system data 925 accessible to system 916 and possibly multiple tenants, program code 926 for implementing various functions of system 916, and an adaptive engine process space 928 for executing MTS system processes and tenant-specific processes, such as running applications as part of an application hosting service. Additional processes that may execute on system 916 include database indexing processes.

Several elements in the system shown in FIG. 9A include conventional, well-known elements that are explained only briefly here. For example, each user system 912 may include a desktop personal computer, workstation, laptop, PDA, cell phone, or any wireless access protocol (WAP) enabled device or any other computing device capable of interfacing directly or indirectly to the Internet or other network connection. User system 912 typically runs an HTTP client, e.g., a browsing program, such as Microsoft’s Internet Explorer browser, a Mozilla or Firefox browser, an Opera, or a WAP-enabled browser in the case of a smartphone, tablet, PDA, or other wireless device, or the like, allowing a user (e.g., a subscriber of the multi-tenant database system) of user system 912 to access, process and view information, pages and applications available to it from system 916 over network 914. Each user system 912 also typically includes one or more user interface devices, such as a keyboard, a mouse, trackball, touchpad, touch screen, pen, or the like, for interacting with a graphical user interface (GUI) provided by the browser on a display (e.g., a monitor screen, LCD display, etc.) in conjunction with pages, forms, applications and other information provided by system 916 or other systems or servers. For example, the user interface device can be used to access data and applications hosted by system 916, and to perform searches on stored data, and otherwise allow a user to interact with various GUI pages that may be presented to a user. As discussed above, embodiments are suitable for use with the Internet, which refers to a specific global internetwork of networks. However, it is understood that other networks can be used instead of the Internet, such as an intranet, an extranet, a virtual private network (VPN), a non-TCP/IP based network, any LAN or WAN, or the like.

According to one embodiment, each user system 912 and all of its components are operator configurable using applications, such as a browser, including computer code run using a central processing unit such as an Intel Pentium® processor or the like. Similarly, system 916 (and additional instances of an MTS, where more than one is present) and all of their components might be operator configurable using application(s) including computer code to run using a central processing unit such as processor system 917, which may include an Intel Pentium® processor or the like, and/or multiple processor units.

According to one embodiment, each system 916 is configured to provide webpages, forms, applications, data, and media content to user (client) systems 912 to support the access by user systems 912 as tenants of system 916. As such, system 916 provides security mechanisms to keep each tenant’s data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS may include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It is understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 9B illustrates another block diagram of an embodiment of elements of FIG. 9A and various possible interconnections between such elements in accordance with the described embodiments. FIG. 9B also illustrates environment 999. However, in FIG. 9B, the elements of system 916 and various interconnections in an embodiment are illustrated in further detail. More particularly, FIG. 9B shows that user system 912 may include a processor system 912A, memory system 912B, input system 912C, and output system 912D. FIG. 9B shows network 914 and system 916. FIG. 9B also shows that system 916 may include tenant data storage 922, having therein tenant data 923, which includes, for example, tenant storage space 927, tenant data 929, and application metadata 931. System data storage 924 is depicted as having therein system data 925. Further depicted within the expanded detail of application servers 900_{1-N} are User Interface (UI) 930, Application Program Interface (API) 932, application platform 918 includes PL/SOQL 934, save routines 936, application setup mechanism 938, adaptive engine (AE) process space 928 includes system process space 902, tenant 1-N AE process spaces 904, and tenant management process space 910. In other embodiments, environment 999 may not have the same elements as those listed above and/or may have other elements instead of, or in addition to, those listed above.

User system 912, network 914, system 916, tenant data storage 922, and system data storage 924 were discussed above in FIG. 9A. As shown by FIG. 9B, system 916 may include a network interface 920 (of FIG. 9A) implemented as a set of HTTP application servers 900, an application platform 918, tenant data storage 922, and system data storage 924. Also shown is system process space 902, including individual tenant AE process spaces 904 and tenant management process space 910. Each application server 900 may be configured to tenant data storage 922 and the tenant data 923 therein, and system data storage 924 and the system data 925 therein to serve requests of user systems 912. The tenant data 923 might be divided into individual tenant storage areas (e.g., tenant storage space 927), which can be either a physical arrangement and/or a logical arrangement of data. Within each tenant storage space 927, tenant data 929, and application metadata 931 might be similarly allocated for each user. For example, a copy of a user’s most recently used (MRU) items might be stored to tenant data 929. Similarly, a copy of MRU items for an entire organization that is a tenant might be stored in tenant storage space 927. A UI 930 provides a user interface and an API 932 provides an application programmer interface into system 916 resident processes to users and/or developers at user systems 912. The tenant data and the system data may be stored in various databases, such as one or more Oracle™ databases.

Application platform 918 includes an application setup mechanism 938 that supports application developers’ creation and management of applications, which may be saved as metadata into tenant data storage 922 by save routines 936 for execution by subscribers as one or more tenant AE process spaces 904 managed by tenant management process space 910 for example. Invocations to such applications may be coded using PL/SOQL 934 that provides a programming language style interface extension to API 932. Invocations to applications may be detected by one or more system processes, which manages retrieval of application metadata 931 for the subscriber making the invocation and executing the metadata as an application in a virtual machine.

Each application server 900 may be communicably coupled to database systems, e.g., having access to system data 925 and tenant data 923, via a different network connection. For example, one application server 900₁ might be coupled via the network 914 (e.g., the Internet), another application server 900_{N-1} might be coupled via a direct network link, and another application server 900_{N} might be coupled by yet a different network connection. Transfer Control Protocol and Internet Protocol (TCP/IP) are typical protocols for communicating between application servers 900 and the database system. However, it will be apparent to one skilled in the art that other transport protocols may be used to optimize the system depending on the network interconnect used.

In certain embodiments, each application server 900 is configured to handle requests for any user associated with any organization that is a tenant. Because it is desirable to be able to add and remove application servers from the server pool at any time for any reason, there is preferably no server affinity for a user and/or organization to a specific application server 900. In one embodiment, therefore, an interface system implementing a load balancing function (e.g., an F5 Big-IP load balancer) is communicably coupled between the application servers 900 and the user systems 912 to distribute requests to the application servers 900. In one embodiment, the load balancer uses a least connections algorithm to route user requests to the application servers 900. Other examples of load balancing algorithms, such as round-robin and observed response time, also can be used. For example, in certain embodiments, three consecutive requests from the same user may hit three different application servers 900, and three requests from different users may hit the same application server 900. In this manner, system 916 is multi-tenant, in which system 916 handles storage of, and access to, different objects, data, and applications across disparate users and organizations.

As an example of storage, one tenant might be a company that employs a sales force where each salesperson uses system 916 to manage their sales process. Thus, a user might maintain contact data, leads data, customer follow-up data, performance data, goals and progress data, etc., all applicable to that user’s personal sales process (e.g., in tenant data storage 922). In an example of an MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user’s data might be separate from other users’ data regardless of the employers of each user, some data might be organization-wide data shared or accessible by a plurality of users or all of the users for a given organization that is a tenant. Thus, there might be some data structures managed by system 916 that are allocated at the tenant level while other data structures might be managed at the user level. Because an MTS might support multiple tenants including possible competitors, the MTS may have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 916 might also maintain system-level data usable by multiple tenants or other data. Such system-level data might include industry reports, news, postings, and the like that are sharable among tenants.

In certain embodiments, user systems 912 (which may be client systems) communicate with application servers 900 to request and update system-level and tenant-level data from system 916 that may require sending one or more queries to tenant data storage 922 and/or system data storage 924. System 916 (e.g., an application server 900 in system 916) automatically generates one or more SQL statements (e.g., one or more SQL queries) that are designed to access the desired information. System data storage 924 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects as described herein. It is understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It is understood that the word “entity” may also be used interchangeably herein with “object” and “table.”

In some multi-tenant database systems, tenants may be allowed to create and store custom objects, or they may be allowed to customize standard entities or objects, for example by creating custom fields for standard objects, including custom index fields. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

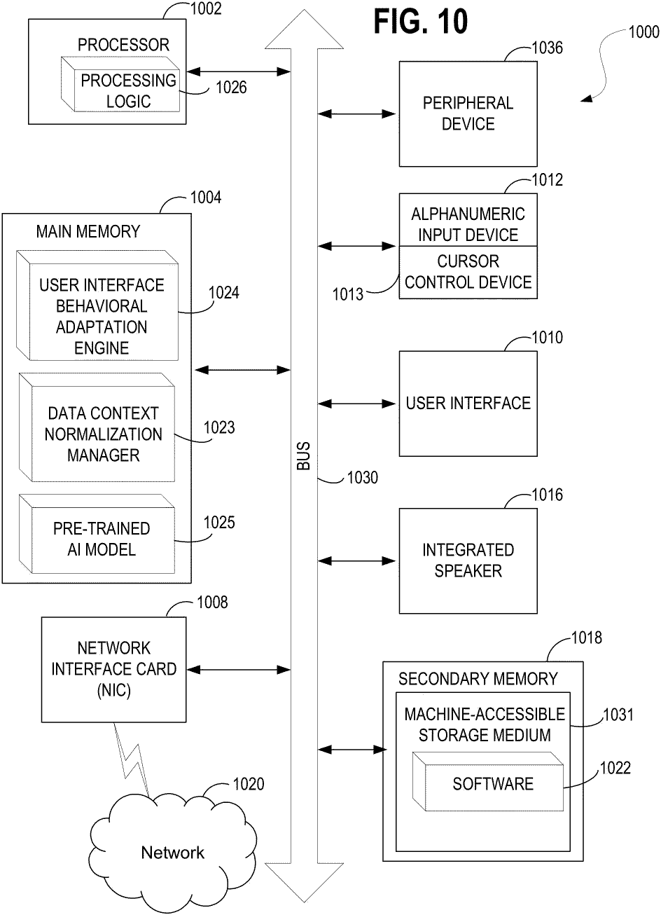

FIG. 10 illustrates a diagrammatic representation of a machine 1000 in the exemplary form of a computer system, in accordance with one embodiment, within which a set of instructions for causing the machine/computer system 1000 to perform any one or more of the methodologies discussed herein, may be executed. In alternative embodiments, the machine may be connected (e.g., networked) to other machines in a Local Area Network (LAN), an intranet, an extranet, or the public Internet. The machine may operate in the capacity of a server or a client machine in a client-server network environment, as a peer machine in a peer-to-peer (or distributed) network environment, or as a server or series of servers within an on-demand service environment. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 1000 includes a processor 1002, a main memory 1004 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 1018 (e.g., a persistent storage device including hard disk drives and a persistent database and/or a multi-tenant database implementation), which communicate with each other via a bus 1030. Main memory 1004 includes a user interface behavioral adaptation engine 1024, data context normalization manager 1023, and pre-trained AI model 1025 by which to process data, such as a pipeline of omni-channel aggregate data. The pre-trained AI model 1025 and the data context normalization manager 1023 may associate the data with a selected user interaction at a GUI 1010 displayed to a user device. The user device may be a device such as peripheral device 1036. The pre-trained AI model 1025 may predict a current emotional state to describe the selected user interaction at the GUI 1010. Pre-trained AI model 1025 may output modifications to the GUI 1010 configured to bring about a target outcome at the user interface 1010, based on the predicted current emotional state to describe the selected user interaction at the GUI 1010. A modified GUI may be generated based on the outputted modifications from pre-trained AI model 1025, for example by user interface behavioral adaptation engine 1024. The modified GUI may then be transmitted to display at the user device, for example at peripheral device 1036.

Data context normalization manager 1023 may include processing data external to the internal environment, such as a pipeline of omni-channel aggregate data, as well as the managing and processing of queries and external data to standardize and normalize data relative to the user, in accordance with described embodiments. Such standardization and normalization may include assigning an emotional state weight-score to data and cleansing aberrations in data such user-inputted cut and paste text being misinterpreted as fast user typing speed and suggesting that the user is angry. User interface behavioral adaptation engine 1024 completes the final step of the BRACE system by implementing the changes to the GUI prescribed by pre-trained AI model 1025 through the execution of processing logic 1026. Such prescribed changes may include modifications to user interface design, colors, and screen flow. Main memory 1004 and its sub-elements are operable in conjunction with processing logic 1026 and processor 1002 to perform the methodologies discussed herein.

Processor 1002 represents one or more general-purpose processing devices such as a microprocessor, central processing unit, or the like. More particularly, the processor 1002 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 1002 may also be one or more special-purpose processing devices such as an application-specific integrated circuit (ASIC), a field-programmable gate array (FPGA), a digital signal processor (DSP), network processor, or the like. Processor 1002 is configured to execute the processing logic 1026 for performing the operations and functionality discussed herein.

The computer system 1000 may further include a network interface card 1008. The computer system 1000 also may include a user interface 1010 (such as a video display unit, a liquid crystal display, etc.), an alphanumeric input device 1012 (e.g., a keyboard), a cursor control device 1013 (e.g., a mouse), and a signal generation device 1016 (e.g., an integrated speaker). The computer system 1000 may further include peripheral device 1036 (e.g., wireless or wired communication devices, memory devices, storage devices, audio processing devices, video processing devices, etc.).

The secondary memory 1018 may include a non-transitory machine-readable storage medium or a non-transitory computer readable storage medium or a non-transitory machine-accessible storage medium 1031 on which is stored one or more sets of instructions (e.g., software 1022) embodying any one or more of the methodologies or functions described herein. The software 1022 may also reside, completely or at least partially, within the main memory 1004 and/or within the processor 1002 during execution thereof by the computer system 1000, with the main memory 1004 and the processor 1002 also constituting machine-readable storage media. The software 1022 may further be transmitted or received over a network 1020 via the network.

While the subject matter disclosed herein has been described by way of example and in terms of the specific embodiments, it is to be understood that the claimed embodiments are not limited to the explicitly enumerated embodiments disclosed. On the contrary, the disclosure is intended to cover various modifications and similar arrangements as are apparent to those skilled in the art. Therefore, the scope of the appended claims is to be accorded the broadest interpretation so as to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

What is claimed is:

1. A system to execute at a host organization, wherein the system comprises:
a memory to store instructions;
a set of one or more processors;
a non-transitory machine-readable storage medium that provides instructions that, when executed by the set of one or more processors, the instructions stored in the memory are configurable to cause the system to perform operations comprising:
receiving a pipeline of omni-channel party data having two or more channels of data from different sources;
training an artificial intelligence (AI) model using the received pipeline of omni-channel party data;
associating the omni-channel party data with a selected user interaction at a graphical user interface (GUI) displayed to a user device;
executing the AI model to predict a current emotional state to describe the selected user interaction at the GUI;
executing the AI model to output modifications to the GUI configured to bring about a target outcome at the user interface, based on the current emotional state as predicted by the AI model;
generating a modified GUI based on the output modifications from the AI model; and
transmitting the modified GUI to display at the user device.

2. The system of claim 1:
wherein the AI model associates the omni-channel party data with the selected user interaction at the GUI displayed to the user device by performing the following operations:
(i) filtering the omni-channel party data, and
(ii) categorizing the omni-channel party data by assigning a weight-score relative to an emotional parameter based on the omni-channel party data.

3. The system of claim 1:
wherein the pipeline of omni-channel party data includes at least two or more of:
(i) first party data, wherein first party data includes user owned data internal to the system including: customer relation management (CRM) data, user inputs including sentiment of user-inputted text, user behavioral data including voice and facial expressions, user GUI interaction data, and user transaction history;
(ii) second party data, wherein second party data includes external user owned data including: social media data, user external account data, user medical records, and user credit reports; and
(iii) third party data, wherein third party data includes non-user owned data and environmental data including: user location and geographic data, weather data, stock market data, demographic data, local news, and national news.

4. The system of claim 1, wherein the instructions, when executed by the set of one or more processors, are configurable to cause the system to perform operations further comprising one or both of the following operations:
(i) predicting the current emotional state to describe the selected user interaction at the GUI; and
(ii) output modifications to the GUI configured to bring about a target outcome at the user interface based on the current emotional state as predicted by the AI model, are based on pre-configured options.

5. The system of claim 1:
wherein predictive capabilities of the AI model are improved via reinforcement learning, wherein the AI model bases one or more of the following on data received from completed user transactions:
(i) predicting the current emotional state to describe the selected user interaction at the GUI, and
(ii) output modifications to the GUI configured to bring about a target outcome at the user interface based on the current emotional state as predicted by the AI model.

6. The system of claim 1:
wherein output modifications to the GUI configured to bring about a target outcome at the user interface based on the current emotional state as predicted by the AI model include changing one or more of user interface:
(i) design, including colors,
(ii) screen flow including expediting or escalating user interactions,
(iii) product presentation, including product type and product description,
(iv) method, frequency, and content of advertising to the user including discounts, promotions, and push notifications, and
(v) relationship status between the user and the user interface, including termination of the user.

7. The system of claim 1:
wherein filtering the omni-channel party data includes one or more of:
(i) standardizing the omni-channel party data,
(ii) filtering out bots and malicious data,
(iii) contextualizing user input and user input rates including typing speed, mouse clicks, user video, and user audio, and
(iv) fine-tuning the omni-channel party data to remove aberrations.

8. The system of claim 1:
wherein the target outcome at the user interface based on the current emotional state as predicted by the AI model is based on a relevant business goal including one or more of:
(i) sales goals,
(ii) customer satisfaction and retention,
(iii) cost function, and
(iv) optimization functions.

9. The system of claim 1:
wherein executing the AI model to predict a current emotional state to describe the selected user interaction at the GUI includes selecting from a configurable and combinable list of individual emotional states based on rule sets, wherein the AI model adds to the list via machine learning.

10. The system of claim 1:
wherein the selected user interaction at the GUI displayed to the user device is an online shopping interaction, wherein the AI model predicts a current emotional state of hesitation to describe the selected user interaction at the GUI based on user mouse movements, wherein the output modifications to the GUI configured to bring about a target outcome at the user interface based on the current emotional state as predicted by the AI model include changing the color and style of the user interface, wherein the omni-channel party data includes one or more of:
(i) live local weather conditions, and
(ii) user transaction history, and
wherein the target outcome at the user interface based on the current emotional state as predicted by the AI model includes making a sale via instilling a desired emotional state of excitement at the selected user interface.

11. The system of claim 1:
wherein the selected user interaction at the GUI displayed to the user device is text-based customer support, wherein the AI model predicts a current emotional state of frustration to describe the selected user interaction at the GUI based on one or more of:
(i) frequency of visits to a website in the last 24 hours,
(ii) user financial data, and
(iii) sentiment of user-inputted text,
wherein the output modifications to the GUI configured to bring about a target outcome at the user interface based on the current emotional state as predicted by the AI model include one or more of:
(i) changing the color and style of the user interface, and
(ii) expediting support process screen flow,
wherein the target outcome at the user interface based on the current emotional state as predicted by the AI model includes satisfactory customer service via instilling a desired emotional state of calm at the selected user interface.

12. The system of claim 1:
wherein the selected user interaction at the GUI displayed to the user device is interaction with a sales prospect, wherein the outputted modifications to the GUI configured to bring about a desired outcome at the user interface includes changing the color and style of the user interface, wherein the desired outcome at the user interface via the modified GUI is to convert the sales prospect into a sale via instilling a desired emotional state of trust at the selected user interface based on the sales prospect perceiving the user interface as optimistic and friendly, wherein the sales prospect becomes receptive to providing leads on information to complete a sale.

13. Non-transitory computer readable storage media having instructions stored thereupon that, when executed by a processor of a system at a host organization, the instructions cause the processor to perform operations including:
receiving a pipeline of omni-channel party data having two or more channels of data from different sources;
training an artificial intelligence (AI) model using the received pipeline of omni-channel party data;
associating the omni-channel party data with a selected user interaction at a graphical user interface (GUI) displayed to a user device;
executing the AI model to predict a current emotional state to describe the selected user interaction at the GUI;
executing the AI model to output modifications to the GUI configured to bring about a target outcome at the user interface, based on the current emotional state as predicted by the AI model;
generating a modified GUI based on the output modifications from the AI model; and transmitting the modified GUI to display at the user device.

14. The non-transitory computer readable storage media of claim 13:
wherein the AI model associates the omni-channel party data with the selected user interaction at the GUI displayed to the user device by performing the following operations:
(i) filtering the omni-channel party data, and
(ii) categorizing the omni-channel party data by assigning a weight-score relative to an emotional parameter based on the omni-channel party data.

15. The non-transitory computer readable storage media of claim 13:
wherein the pipeline of omni-channel party data includes at least two or more of:
(i) first party data, wherein first party data includes user owned data internal to the system including: customer relation management (CRM) data, user inputs including sentiment of user-inputted text, user behavioral data including voice and facial expressions, user GUI interaction data, and user transaction history;
(ii) second party data, wherein second party data includes external user owned data including: social media data, user external account data, user medical records, and user credit reports; and
(iii) third party data, wherein third party data includes non-user owned data and environmental data including: user location and geographic data, weather data, stock market data, demographic data, local news, and national news.

16. The non-transitory computer readable storage media of claim 13, wherein the instructions, when executed by the processor, cause the system to further perform one or both of the following operations:
(i) predicting the current emotional state to describe the selected user interaction at the GUI; and
(ii) output modifications to the GUI configured to bring about a target outcome at the user interface based on the current emotional state as predicted by the AI model, are based on pre-configured options.

17. A computer-implemented method executed via a processor of a system at a host organization, comprising:
executing instructions for a receive interface via the processor of the system and exposing the receive interface at the host organization;
receiving, via the receive interface, a pipeline of omni-channel party data having two or more channels of data from different sources;
training an artificial intelligence (AI) model using the received pipeline of omni-channel party data;
associating the omni-channel party data with a selected user interaction at a graphical user interface (GUI) displayed to a user device;
executing the AI model, via the processor of the system, to predict a current emotional state to describe the selected user interaction at the GUI;
executing the AI model to output modifications to the GUI configured to bring about a target outcome at the user interface, based on the current emotional state as predicted by the AI model;
generating a modified GUI based on the output modifications from the AI model; and
transmitting the modified GUI to display at the user device.

18. The method of claim 17:
wherein the AI model associates the omni-channel party data with the selected user interaction at the GUI displayed to the user device by performing the following operations:
(i) filtering the omni-channel party data, and
(ii) categorizing the omni-channel party data by assigning a weight-score relative to an emotional parameter based on the omni-channel party data.

19. The method of claim 17:
wherein the pipeline of omni-channel party data includes at least two or more of:
(i) first party data, wherein first party data includes user owned data internal to the system including: customer relation management (CRM) data, user inputs including sentiment of user-inputted text, user behavioral data including voice and facial expressions, user GUI interaction data, and user transaction history;
(ii) second party data, wherein second party data includes external user owned data including: social media data, user external account data, user medical records, and user credit reports; and
(iii) third party data, wherein third party data includes non-user owned data and environmental data including: user location and geographic data, weather data, stock market data, demographic data, local news, and national news.

20. The method of claim 17:
wherein one or more of:
(i) predicting the current emotional state to describe the selected user interaction at the GUI, and
(ii) output modifications to the GUI configured to bring about a target outcome at the user interface based on the current emotional state as predicted by the AI model, are based on pre-configured options.
